(19) United States
(12) Patent Application Publication
(10) Pub. No.: US 2001/0013855 A1
(43) Pub. Date: Aug. 16, 2001

(54) RESISTIVE AND CAPACITIVE TOUCHPAD

(76) Inventors: JEAN-PHILIPPE FRICKER, MOUNTAIN VIEW, CA (US); MAURICE ALOU, MENLO PARK, CA (US); BERNARD KASSER, REDWOOD CITY, CA (US)

Correspondence Address: PAUL C HAUGHEY, TOWNSEND AND TOWNSEND AND CREW, TWO EMBARCADERO CENTER, 8TH FLOOR, SAN FRANCISCO, CA, 941113834

(21) Appl. No.: 09/097,235

(22) Filed: Jun. 12, 1998

(51) Int. Cl. G09G 5/00

(52) U.S. Cl. 345/156

(57) ABSTRACT

A touchpad having the advantages of resistive and capacitive type sensors. A capacitive sensor is stacked above a 5-wire resistive sensor. The touchpad is of integrated manufacture with one of conductive plates of the resistive sensor printed on a first substrate, and the other conductive plate printed on the second substrate with the capacitive sensor. The touchpad is configurable to distinguish between a finger and a pen, and operate in different modes depending on which is being used.

### BACKGROUND OF THE INVENTION

The present invention relates to input devices for digital systems, and more particularly to a touchpad that detects the position and motion of a pointing element using both resistive and capacitive sensing.

Touchpads are well-known input devices for digital systems such as personal computers, games, hand held personal organizers, and the like. They operate by detecting the presence and movement of a pointing element such as a pen, a stylus, or a finger. Movement of the pointing element is translated into movement of a cursor on a display screen or other commands that are recognizable by the machine. Also, tapping the touchpad with the pointing element may be translated into button operations, much like a mouse button.

Typically, two general types of sensors have been advantageously used to sense the presence and movement of the pointing element. These general types include capacitive sensors and resistive sensors. Each type of sensor has its various advantages and disadvantages. Different applications will often benefit more by using one type of sensor over the other.

Capacitive sensors operate by sensing a change in capacitance due to the presence of the pointing element. They typically use an array of horizontal and vertical traces arranged in a grid. The horizontal traces reside in one plane and vertical traces reside in a second plane. The intersection points of the traces define an X-Y coordinate system. The capacitive sensor measures the capacitance of the traces in the horizontal plane and the vertical plane. The presence of the pointing element is recognized by an increase in the capacitance on those traces in the pointing element's immediate vicinity. The position of the pointing element may then be determined by the X-Y coordinates of the center of the traces with the increased capacitance or by a similar methodology.

Resistive sensors typically rely on pressure exerted by the pointing element on the touchpad to cause two conductive layers to come into contact. As the conductive layers come into contact, they form an electrical connection. A voltage gradient may be applied across one of the conductive layers, and the voltage level of the second conductive layer measured to determine the voltage at the location at which contact has been made. The location of the pointing element may be determined from this voltage level.

Each of the above methods has various advantages and disadvantages making them more suitable for certain applications. For example, capacitive sensors work well for detecting the presence of a finger, because a finger causes a significant change in the capacitance. Consequently, they are most often used for small touchpads in which the main application is as a cursor controller. However, they do not work so well with a pen, since a pen typically does not cause a significant change in the capacitance.

Similarly, a resistive sensor is advantageous for detecting the presence of a pen because it causes a connection at a precise point, whereas a finger is not detected well by a resistive sensor, since it does not have a small surface area of contact. Further, since a resistive sensor requires pressure, a finger will stick to the surface and not move easily when it is firmly pressed on the touchpad. Applying pressure with a pen does not cause the same problem because of the small surface area at which contact is made by the pen. Because of these characteristics, resistive type sensors find relatively widespread use in large size writing tablets.

Two modes of operation are typical for pointing type devices. The first is absolute mode. In absolute mode, the pointing device is mapped directly to the display screen. So, if the pointing element is raised and moved to another location, the cursor is moved to the new location. This mode is especially useful for handwriting applications because most characters are formed by several pen strokes in which the relative location of the pen strokes is an important element. In contrast, in relative mode, the pointing device is mapped relative to the last location. In relative mode, if the pointing element is raised and moved, the cursor remains at the same location it was at before it was moved. Movement of the pointing element when it is not in contact with the pointing device is ignored. Relative mode is desirable for cursor movement applications such as mouse simulation.

Currently, a combination resistive and capacitive touchpad is available from Synaptics, Inc., in San Jose, Calif. The Synaptics touchpad combines an independent capacitive sensor with an independent resistive sensor to make the combination sensor. The capacitive and resistive sensors are designs that have previously been available independently, and have been packaged together as a single unit by attaching the capacitive sensor above the resistive sensor. The resistive sensor of Synaptics' touchpad is a 4-wire sensor with two conductive plates as is well-known in the art. The two conductive plates are printed on a single substrate that is folded over to position one above the other. An independent spacer is located between the two conductive plates to maintain a separation between the conductive plates.

Currently available touchpads have limitations in their manufacture and usability. Thus an improved touchpad is desirable

### SUMMARY OF THE INVENTION

An improved touchpad having the advantages of resistive and capacitive type sensors is provided. The improved touchpad is an integrated design which is easier and less costly to manufacture than currently available touchpads.

In particular, in an embodiment of the present invention, a touchpad is provided with a 5-wire resistive sensor and a capacitive sensor. The resistive sensor has two conductive plates referred to herein as resistive plane and sensor plane, respectively. The resistive plane is printed on a first substrate, while the resistive plane is printed on the second substrate. Because the two planes can be printed on the substrates, they are easier to manufacture than those currently on the market. Further, a routing layer may be integrated in the capacitive sensor.

In another aspect of the present invention, the touchpad is configurable to distinguish between different types of pointing elements that are used. Using this information, a system utilizing the touchpad is configurable to adapt its operation to take advantage of users tendencies to use certain pointing elements to accomplish certain tasks.

For example, in an embodiment of the present invention, if the capacitive sensor detects finger as the pointing element, the system automatically operates in relative mode, and it determines that the pointing element is a pen, the system operates in relative mode.

In yet another aspect of the present invention, the awareness of the type of pointing element may be used to determine how the system will respond to touchpad use. For example, if a finger is detected, the system may use the touchpad to control a cursor, much like a mouse is currently used. However, if a pen is detected, the touchpad may operated as a drawing pad or other pen type application. Details of various applications will be described in more detail below.

According to another embodiment of the present invention, if the capacitive sensor detects a finger, the resistive sensor is turned off. By doing so, the touchpad can save power for applications that require low power operation.

A further understanding of the nature and advantages of the present invention may be realized by reference to the remaining portions of the specification and the drawings.

### BRIEF DESCRIPTION OF THE DRAWINGS

FIG. 1 is a block diagram of a digital system within which the present invention may be embodied;

FIG. 2 shows the overall structure of a specific embodiment for a touchpad according to the present invention;

FIG. 3A is a more detailed drawing of a resistive sensor according to the present invention;

FIGS. 3B and 3C are different embodiments of capacitive sensors according to the present invention;

FIGS. 4A-4F are drawings of the various layers of the resistive sensor of FIG. 3A;

FIG. 5 shows a circuit diagram of a resistive sensor according to the present invention;

FIGS. 6A-4G are drawings of the various layers of the capacitive sensor of FIG. 3B;

FIGS. 7A-4I are drawings of the various layers of the capacitive sensor of FIG. 3C;

FIG. 8 shows the capacitive influences in a capacitive sensor;

FIG. 9 shows a representative graph of changed capacitances for the traces in a capacitive sensor according to the present invention;

FIG. 10 is a flowchart of a method for detecting whether a pen or a finger is being used on a touchpad.

### DETAILED DESCRIPTION OF THE SPECIFIC EMBODIMENT

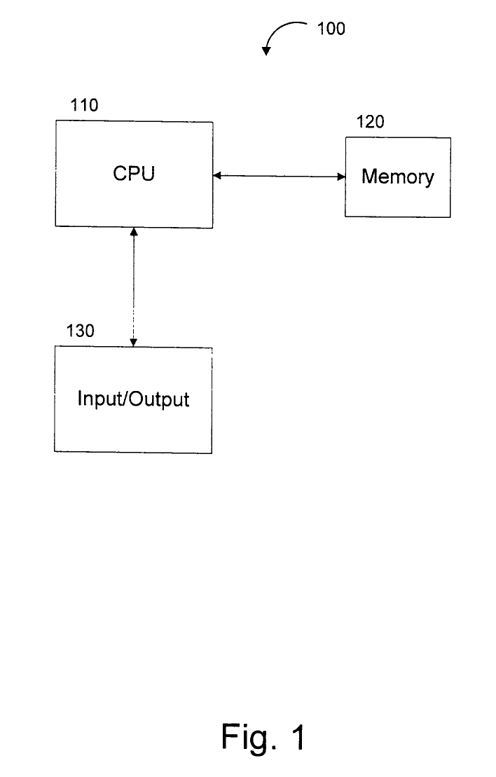

FIG. 1 is a block diagram of a digital system 100 within which the present invention may be embodied. A personal computer is an example of digital system 100, although many other devices such as personal organizers, television set-top boxes, keyboards, and the like implementing the principles of the present invention may be readily envisioned. Digital system 100 contains a CPU 110, a memory 120, and an input/output device 130. CPU 110 is the main controller of digital system 100 and may be a microprocessor, microcontroller, or other intelligent processing device. Memory 120 is coupled to CPU 110 and provides data storage for programs and data. Input/output device 130 is also coupled to CPU 110 for receiving user input and outputting results. Input/output device 130 may also be coupled to memory 120 for direct memory access. Input/output device 130 may include, for example, a touchpad of the present invention.

Digital system 100 may execute code with CPU 110. The programs may be stored in memory 120. Memory 120 may include semiconductor memory, fixed, or removable storage mediums. Alternatively, the programs may be input through input output device 130. The code may include operating system or application programs and may be written in any of a variety of programming languages.

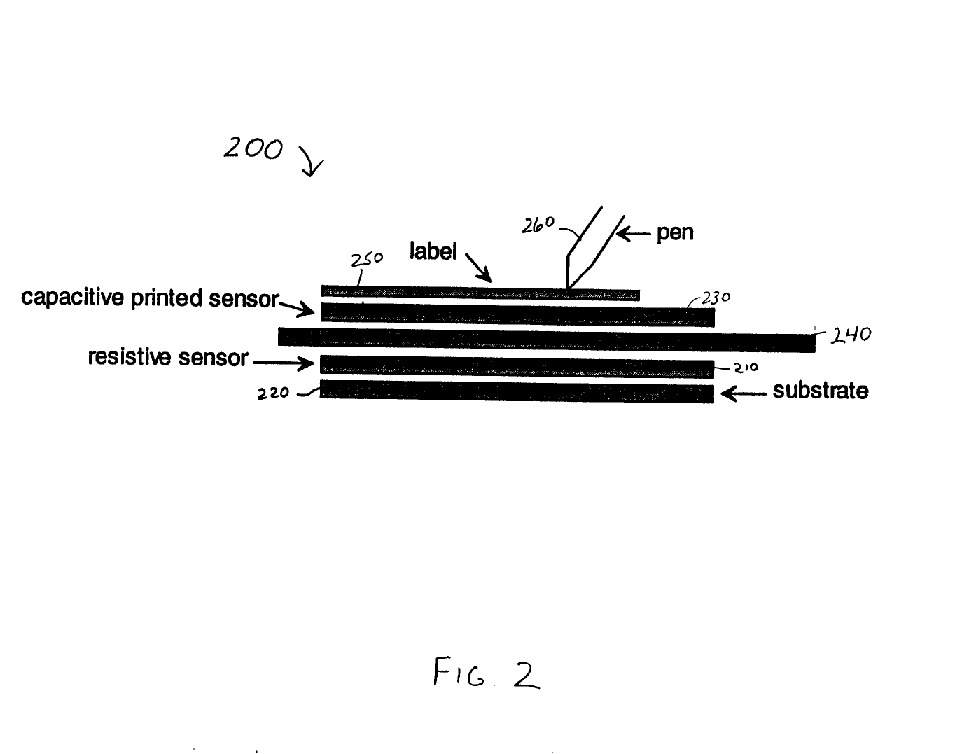

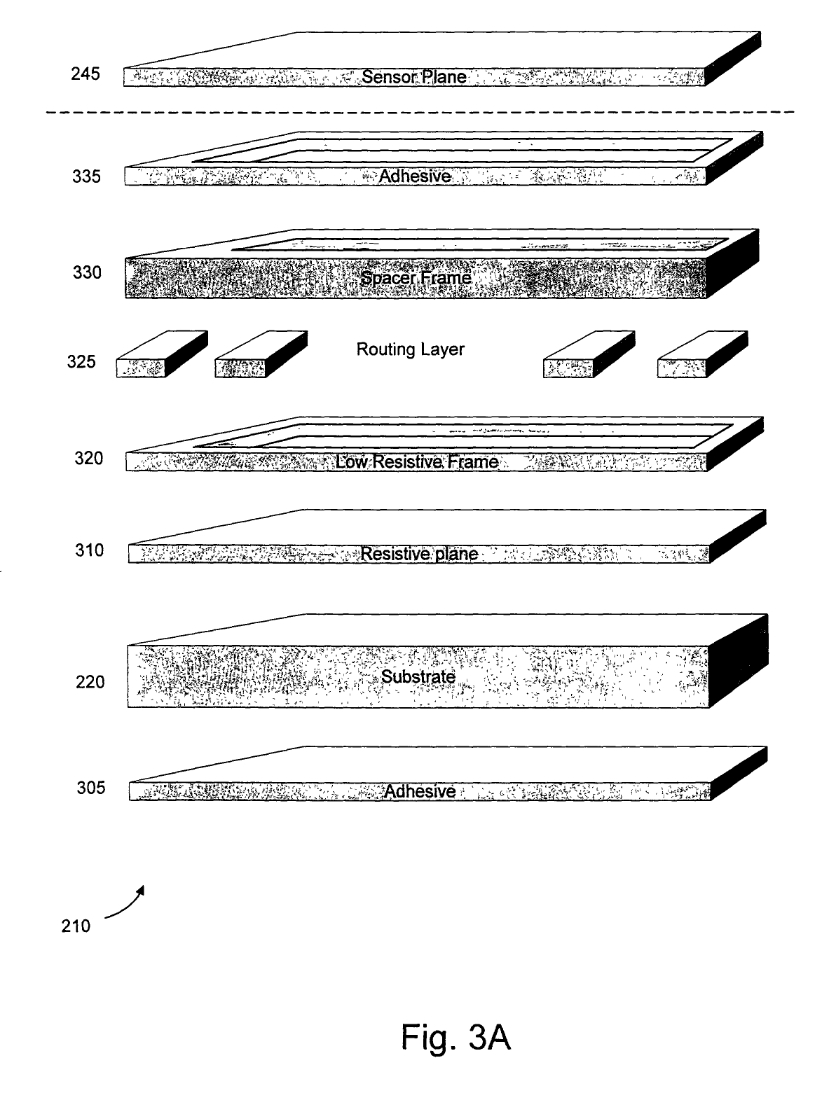

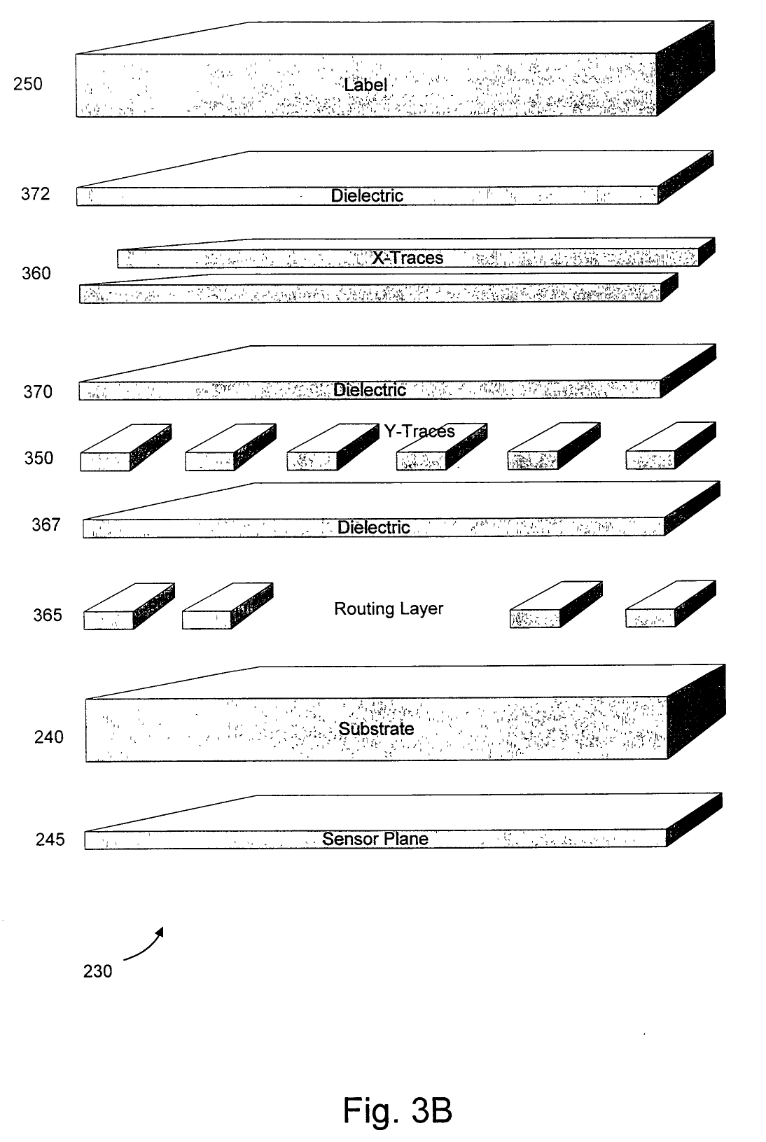

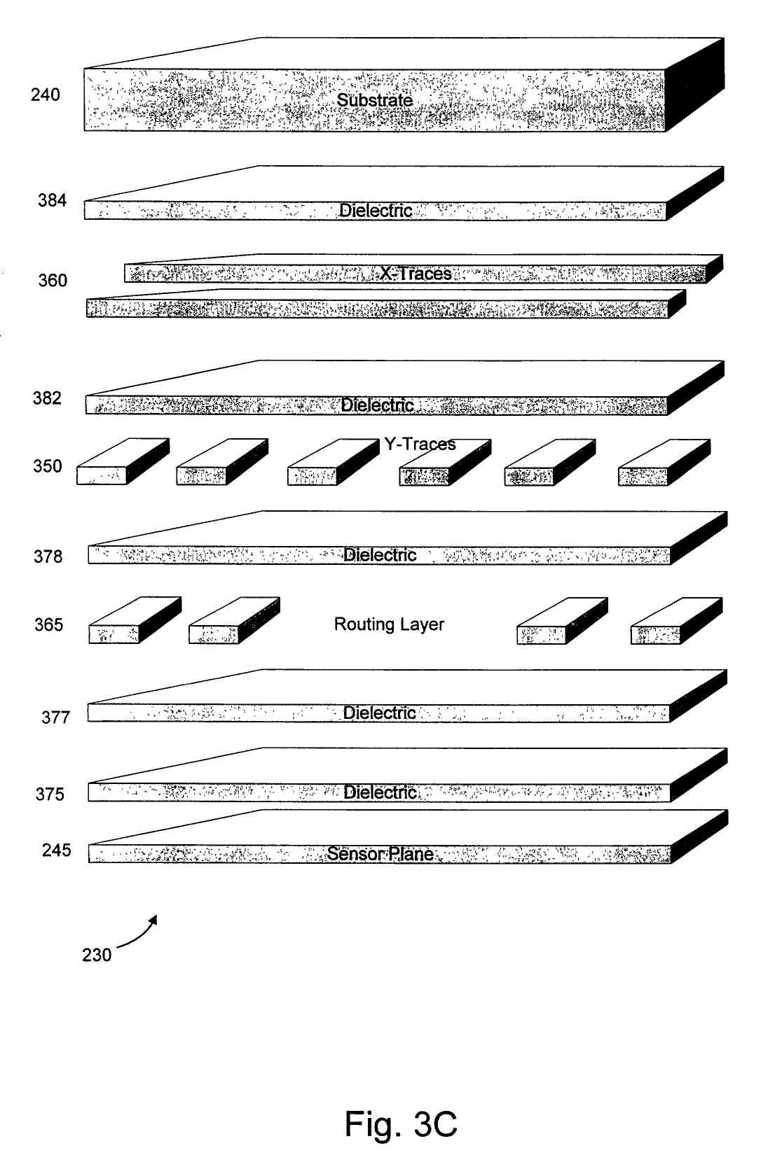

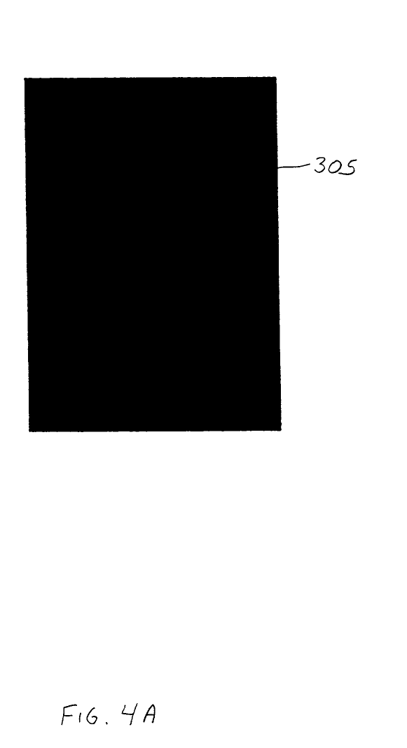

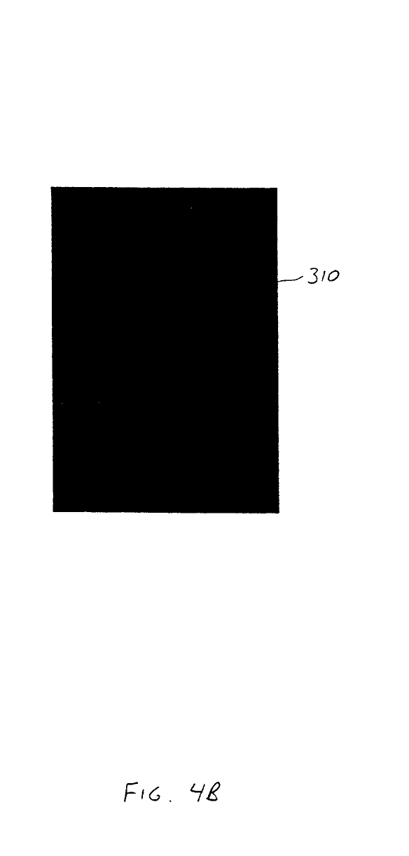

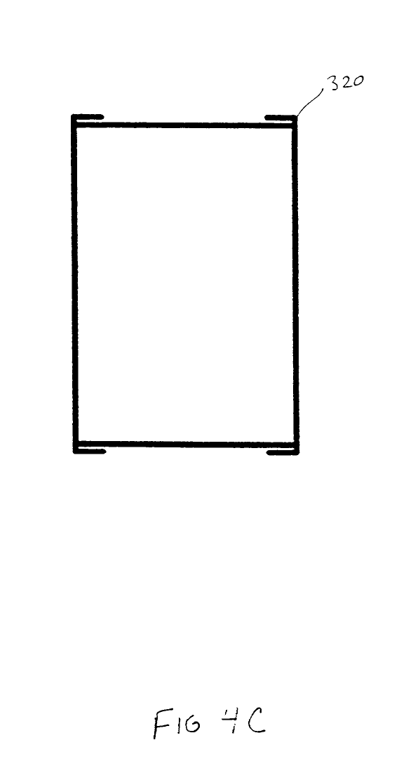

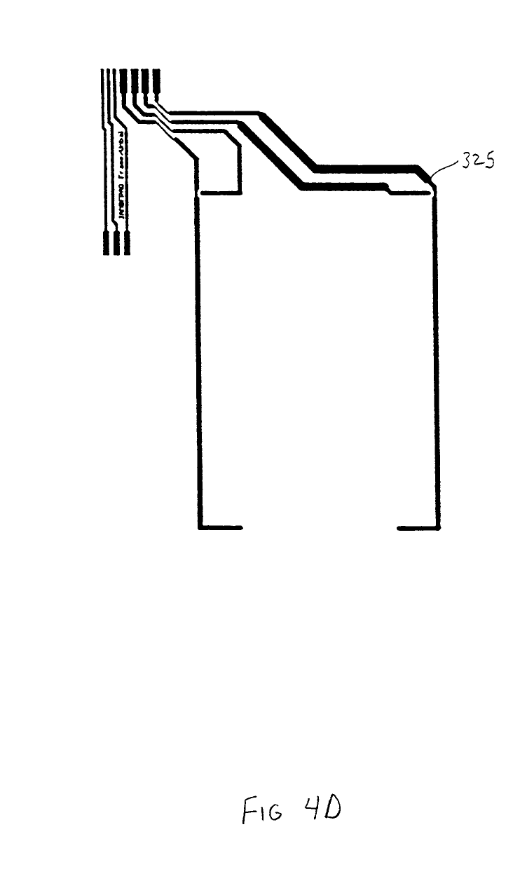

FIG. 2 shows the overall structure of a specific embodiment for a touchpad 200 according to the present invention. It includes a resistive sensor 210 and a capacitive sensor 230. Resistive sensor 210 is formed on a base substrate 220. Capacitive sensor 230 is mounted on a flexible substrate 240. A label 250 may be included to provide decoration and protection to touchpad 200. Resistive sensor 210 and capacitive sensor 230 are described in more detail below with respect to FIGS. 3A-3C. Substrates 220 and 240 provide electrical isolation for sensors 210 and 230.

In operation, touchpad 200 senses the existence and position of a pointing element 260. FIG. 2 depicts pointing element 260 as a pen, however, pointing element 260 may be a finger, a stylus, a pen, or a variety of other devices a user may use to point and move on touchpad 200. In the specific embodiment, touchpad 200 senses the position of pointing element 260 in two different ways. If capacitive sensor 230 senses a change in capacitance, then resistive sensor 210 is turned off and the presence and position of pointing element 260 is determined by capacitive sensor 230. If no change in capacitance is sensed, then resistive sensor 210 is turned on and the presence and position of pointing element 260 is determined by resistive sensor 210. Other embodiments may operate differently, although this provides the advantage of working well for fingers or pens. It is also in accordance with the normal usage of touchpads by users of personal computers wherein the finger is used for cursor manipulation as a default operation, and only certain applications call for the use of a pen. A further advantage of this operation is that by turning off resistive sensor 210, power is saved because the resistive sensor requires a voltage drop across a resistance. This is advantageous to systems that require low power operation, such as laptop computers and the like. By turning off resistive sensor 210 when capacitive sensor 230 is being used, power can be saved, thereby increasing battery life.

In the specific embodiment, resistive sensor 210 is located below capacitive sensor 230. In other embodiments, resistive sensor 210 may be located above capacitive sensor 230. The specific embodiment shown in FIG. 2 provides some advantages over the alternative embodiment. For example, resistive sensor 210 may shield some of the capacitive effect of the pointing element on capacitive sensor 230 if it is between capacitive sensor 230 and pointing element 260.

FIGS. 3A-3C show more detailed diagrams of two specific embodiments of touchpad 200. Resistive sensor 210 is shown in FIG. 3A, while two different embodiments of capacitive sensor 230 are shown in FIGS. 3B and 3C, respectively. Either of the capacitive sensors 230 shown in FIGS. 3B or 3C may be coupled with resistive sensor 210 to form a touchpad 200 of the present invention. In each of the drawings, the various elements are shown separately for clarity; however, in touchpad 200 each of the elements are physically attached by some means to the elements directly above and below them.

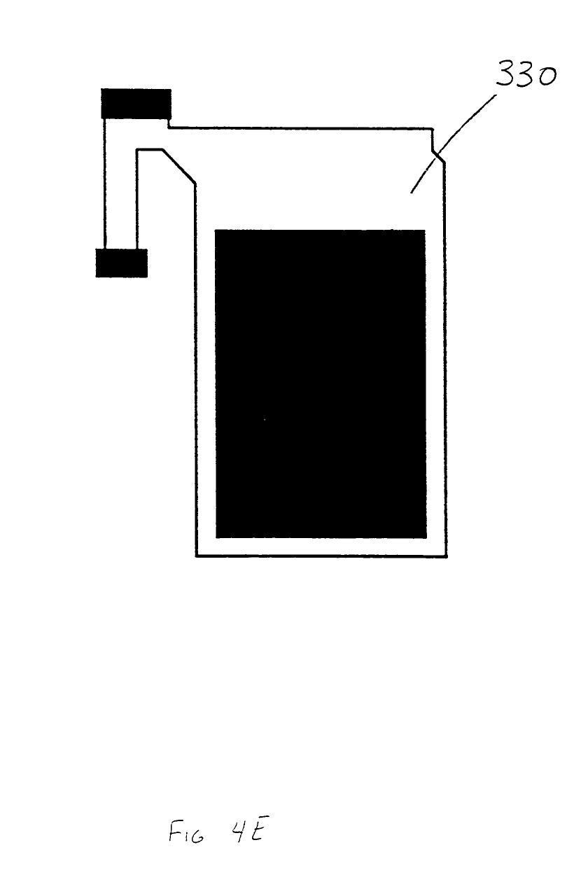

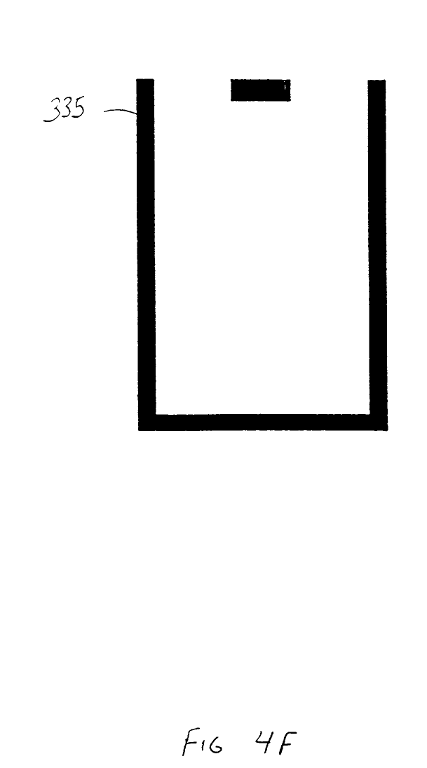

Base substrate 220 is the bottom layer of touchpad 200. It electrically isolates touchpad 200 from a surface to which touchpad 200 is attached In the specific embodiment, base substrate 220 is a polyester film. An adhesive layer 305 is applied beneath substrate 220 to attach touchpad 200 to a housing (not shown). Base substrate 220 may be attached, for example, to the housing of a digital electronic device such as a laptop computer, a keyboard, a game, a hand held personal information device, and the like. Of course, it may also be separately housed in its own casing. FIG. 4A is a drawing of the specific embodiment of adhesive layer 305.

A resistive plane 310 lies above base substrate 220. Each of the corners of resistive plane 310 have a terminal for coupling to a voltage source. In the specific embodiment, resistive plane 310 is a carbon ink that is printed onto base substrate 220. In the specific embodiment, the resistivity of resistive plane 310 is around 50 kilo-ohms/square. In operation, resistive plane 310 is coupled at the terminals on two adjacent corners to a first voltage sources and on the terminals at the other two corners to a second voltage source, which is preferably GROUND. This establishes a voltage gradient across the length of resistive plane 310. Then, the voltages on two of diagonally disposed corners are swapped, and a voltage gradient is established across the width. FIG. 4B is a drawing of the specific embodiment of resistive plane 310.

A low resistive frame 320 is printed above resistive plane 310. Low resistive frame 320 is of much lower resistivity than resistive plane 310. For example, the resistivity may be approximately 500 ohms/square. In the specific embodiment, low resistive frame 320 is carbon ink printed on resistive plane 310. As is well-known to those of skill in the art, the voltage gradient is generally not uniform across resistive plane 310 due to corner and edge effects. Low resistive frame 320 is designed to lessen these anomalous effects. Various techniques have been used in the past to lessen these effects. In the specific embodiment, low resistive frame 320 is a rectangular trace surrounding the perimeter of resistive plane 310. FIG. 4C shows a drawing of the specific embodiment of resistive frame 320. Other geometric shapes may also be preferably used to lessen the anomalous voltage gradient effects due to the corners and edges of resistive plane 310. These known techniques, and those that may yet be developed may be substituted for low resistive frame 320.

Next, a routing layer 325 is printed above resistive frame 320. Routing layer 325 couples the voltages sources to the corners of resistive frame 320. A highly conductive material, such as silver ink is preferably used to create the routing traces in routing layer 325. These routing traces are coupled to the two voltage sources. FIG. 4D shows a preferred layout of routing layer 325.

A spacer frame 330 is printed above routing layer 325. Spacer frame 330 is a dielectric material designed to provide a space separating resistive plane 310 from sensor plane 245. Spacer frame 330 surrounds the border of resistive plane 310. It typically has a thickness of approximately 0.1 mm and defines a window into resistive plane 310. The window is the active area of resistive sensor 210. FIG. 4E is a drawing of the specific embodiment of spacer frame 330. The dark area is the center is the window area.

In the specific embodiment, an adhesive layer 335 is applied to spacer frame 330. Adhesive 335 bonds resistive sensor 210 to capacitive sensor 230. FIG. 4F is a drawing of the specific embodiment of adhesive 335. As can be seen in FIG. 4F, adhesive 335 is preferably not continuous around the entire periphery of spacer frame 330. Rather, one or more openings in adhesive 335 allow the pressure inside and outside of resistive sensor to equalize.

Sensor plane 245 is printed on the same substrate as capacitive sensor 230, which will be described below with respect to FIGS. 3B and 3C. Although physically printed on a separate substrate from the other elements, it is an element of resistive sensor 210. Adhesive 335 may be used to connect to two substrates. Sensor plane 245 is a conductive material that is flexible enough to contact resistive plane 310 when pressure is applied by pointing element 260. In the specific embodiment, sensor plane 245 is a mixture of carbon and silver ink, although other conductive materials may be preferably used, as long as they have low resistivity.

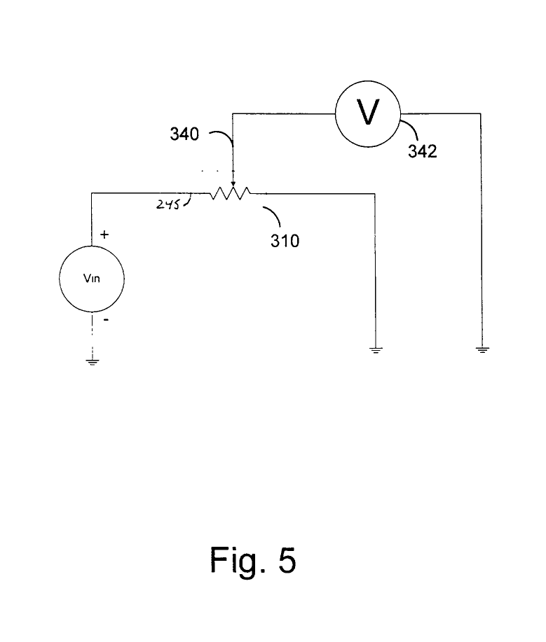

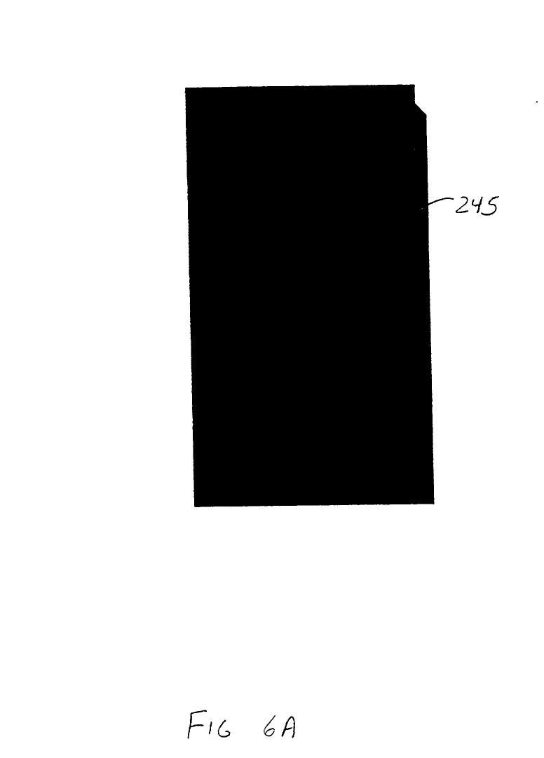

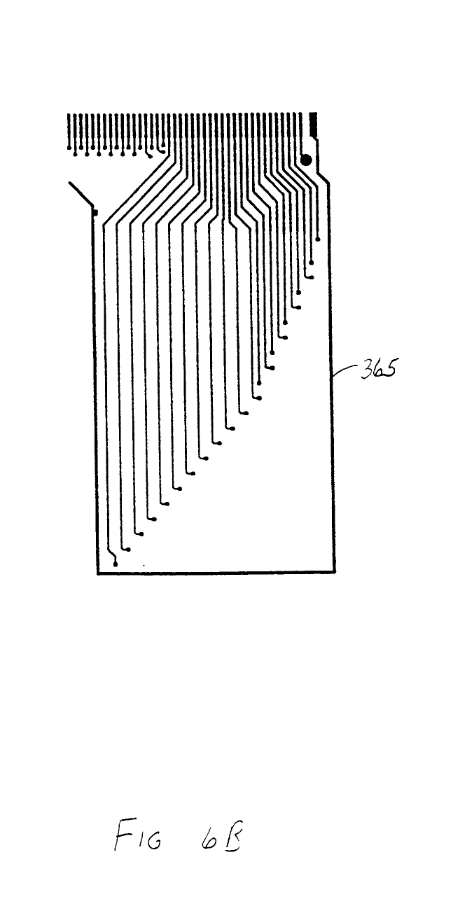

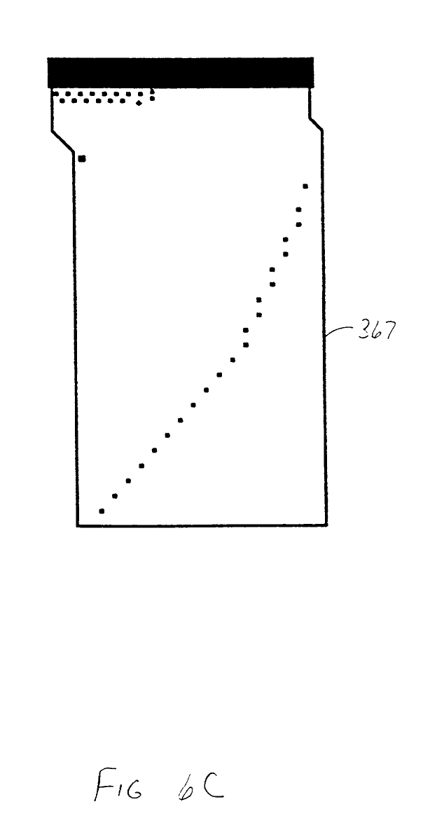

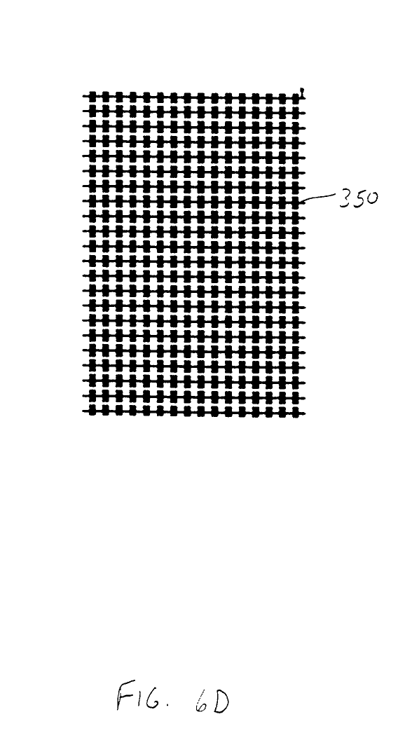

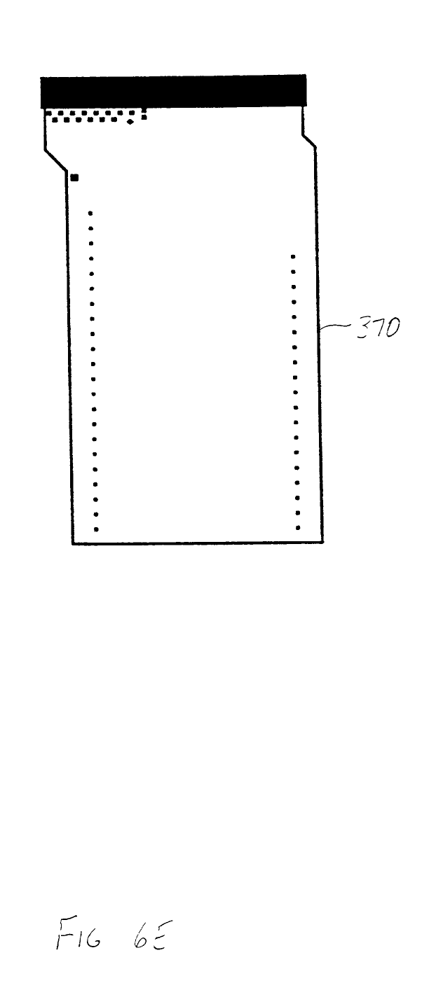

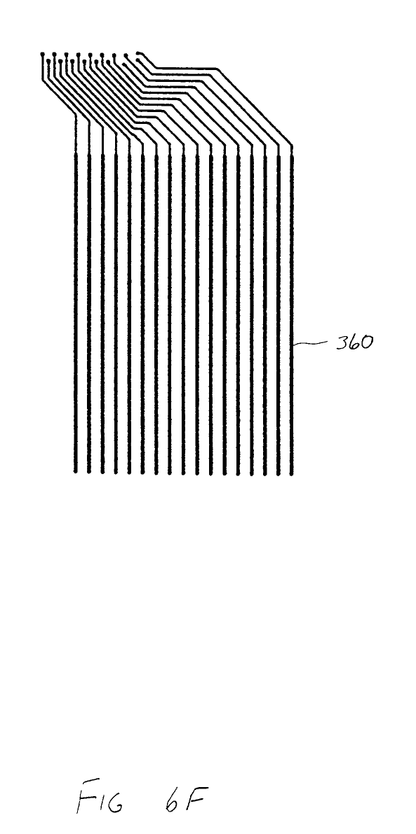

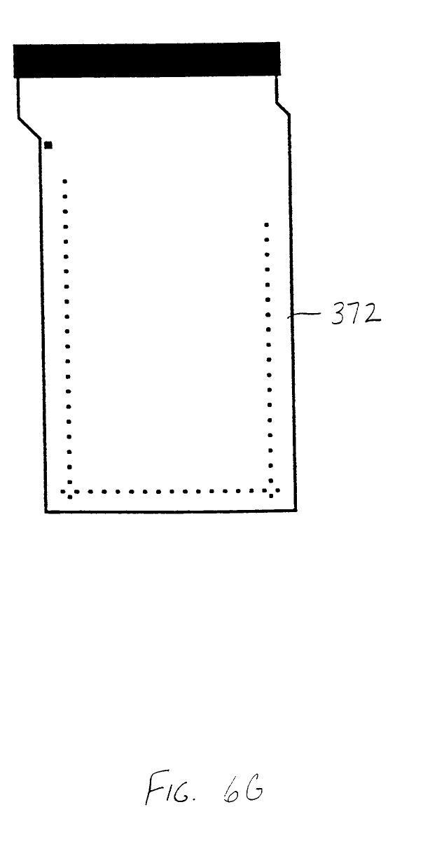

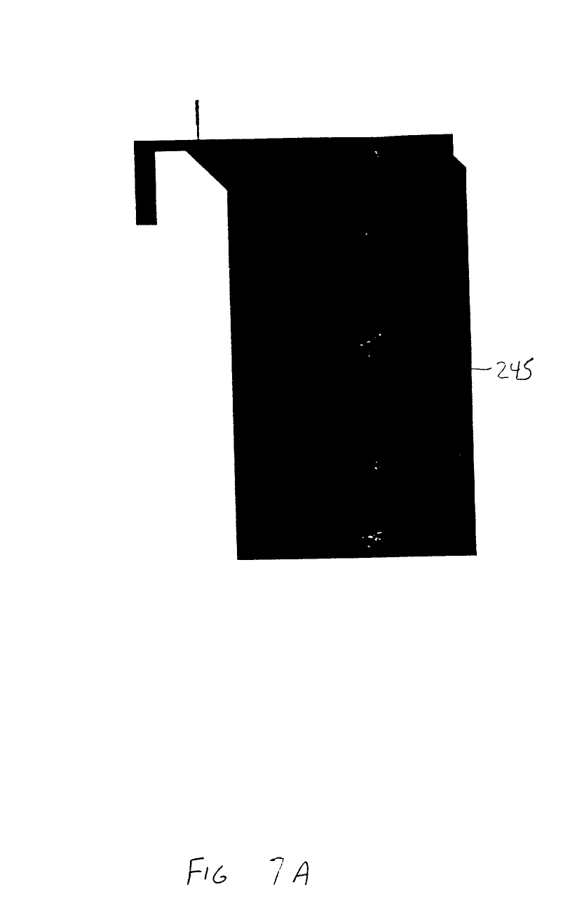

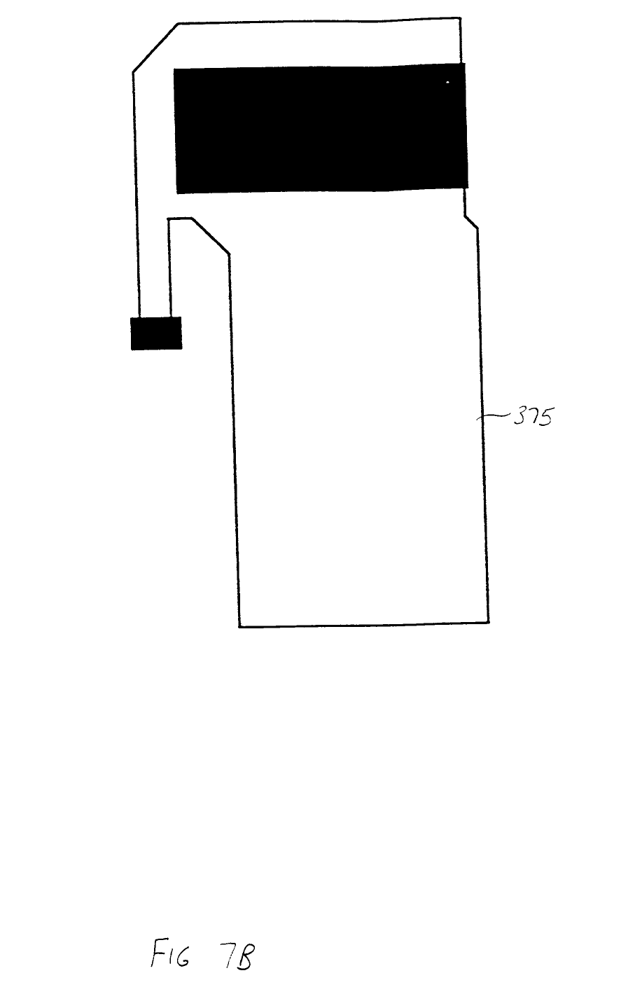

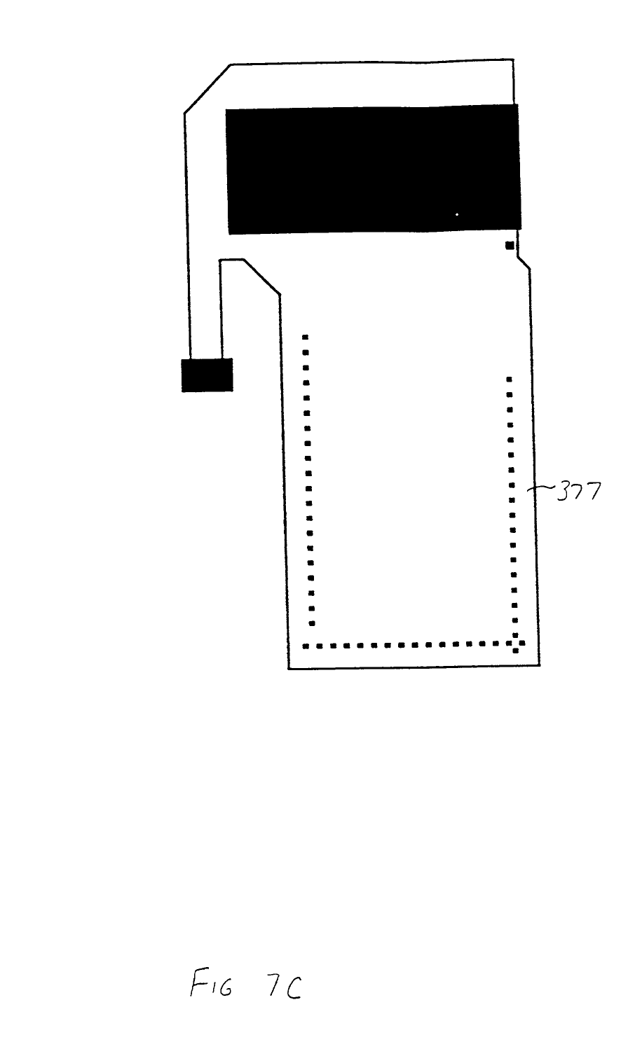

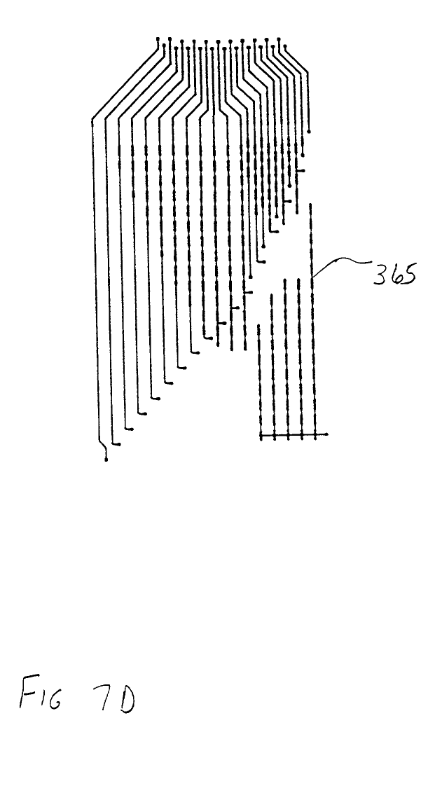

Referring to FIG. 5, a diagram of the circuitry surrounding resistive sensor 210 is shown. Resistive plane 310 is represented by a resistor symbol, while sensor plane 245 is represented by an arrow pointing to an arbitrary distance along resistive plane 310. A voltmeter 342 is coupled to sensor plane 245. When sensor plane 245 is depressed and makes contact with resistive plane 310, voltmeter 342 measures the voltage at the point of contact. The design of an appropriate voltmeter 342 is well known. The value measured by voltmeter 342 is used to determine the location of pointing element 260.

In operation, resistive sensor 310 works as follows. In its equilibrium position, sensor plane 245 is physically separated and electrically isolated from resistive layer 310 by spacer frame 330. When pointing element 260 applies pressure to sensor plane 245, it makes an electrical connection between sensor plane 245 and resistive plane 310. A voltage is applied to two adjacent corners of resistive layer 310. The other two corners are coupled to GROUND. This establishes a voltage gradient of decreasing voltages from the corners at which the voltage is applied to the grounded corners. Sensor plane 245 senses the voltage at the point of contact and voltmeter 342 measures that voltage. An X-coordinate of the position is calculated from the voltage value, typically by software in the digital system. Then, the voltage sources are swapped on two of the corners that are diagonally disposed with respect to each other and the operation is repeated to determine the Y-coordinate of the contact.

It will be recognized by one of skill in the art, that resistive sensor 210 is a 5-wire resistive sensor. A 4-wire design may be substituted for the 5-wire resistive sensor without departing from the spirit and scope of the present invention.

Referring to FIG. 3B, capacitive sensor 230 lies above resistive sensor 210. Capacitive sensor 230 comprises a set of Y-traces 350 and a set of X-traces 360 printed on flexible substrate 240. X-traces 360 and Y-traces 350 comprise a set of conductive traces that are organized into rows with X-traces 360 being substantially perpendicular to Y-traces 350. Although only a few traces are shown for each of X-traces 360 and Y-traces 350, they may include many traces in an actual touchpad. The number of traces influence the amount of resolution available for touchpad 200. In the specific embodiments, there are 22 X-traces 360 and 17 Y-traces 350, although other numbers of traces may also be preferably used. This arrangement forms a grid defining an X-Y coordinate system. Preferably, X-traces 360 and Y-traces 350 are printed with silver ink.

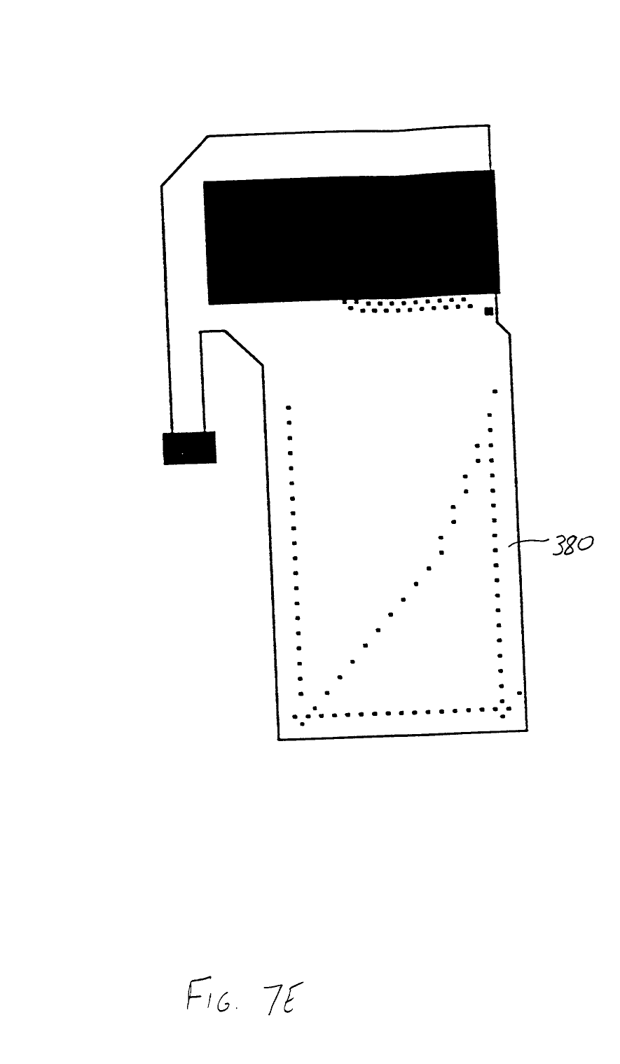

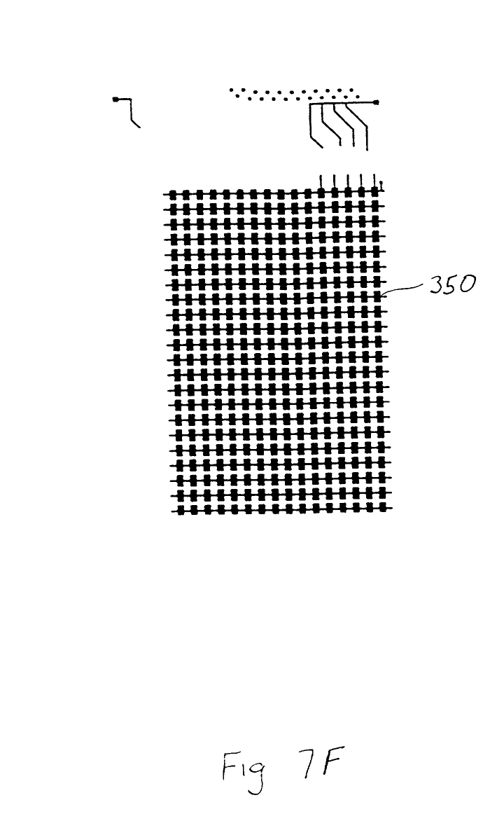

A routing layer 365 is printed above substrate 240. Routing layer 365 is used to couple each of Y-traces 350 to a current source (not shown). It is desirable that the traces in routing layer 365 be as short as possible. This reduces the amount of capacitance on the traces and allows the device to operate at higher frequencies. Also, as can be seen in FIG. 6B, longer traces are spaced further apart. This reduces the inter-wire capacitance of the traces. Dielectric layers 367 and 370 electrically isolates X-traces 360, Y-traces 350, and routing layer 365 from one another. Label 250 is attached to capacitive sensor 230 by means of an adhesive (not shown) and separated by a dielectric layer 372 from X-traces 360. FIGS. 6A-6G are drawings of the first specific embodiment for each of the layers on substrate 240.

FIG. 3C shows a second embodiment of capacitive sensor 230. In the second embodiment, there is no label 250. Instead, substrate 240 fulfills the purpose of label 250 and the rest of capacitive sensor 230 is printed below it. A layer of paint (not shown) may be applied directly beneath substrate 240 to give it a pleasant appearance, and a material (not shown) may also be applied to the surface of substrate 240 to give an appropriate feel and texture to touchpad 200.

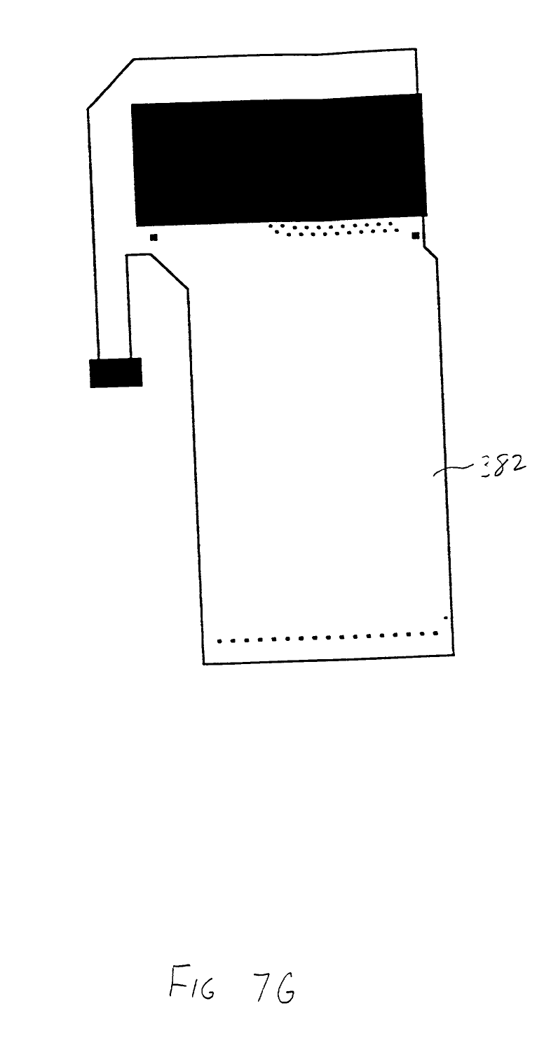

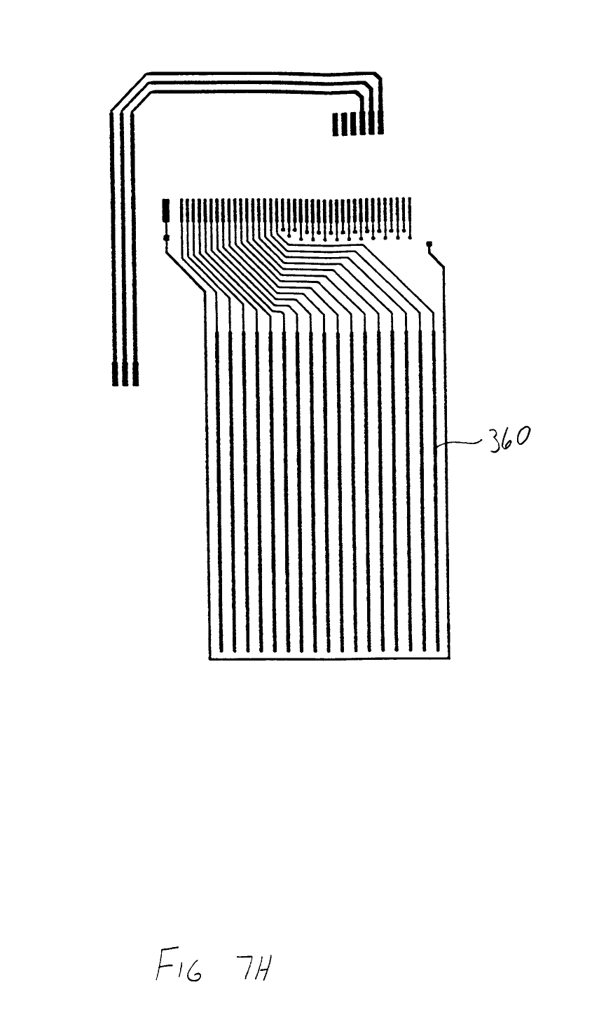

FIGS. 7A-7I are drawings of each of the remaining layers of the second embodiment of capacitive sensor 230 as shown in FIG. 3C. Sensor plane 245 is printed on two dielectric layers 375 and 377. The dielectric layers are printed on routing layer 365 above which are Y-traces 350 and X-traces 360, all separated by dielectric layers 378, 382, and 384.

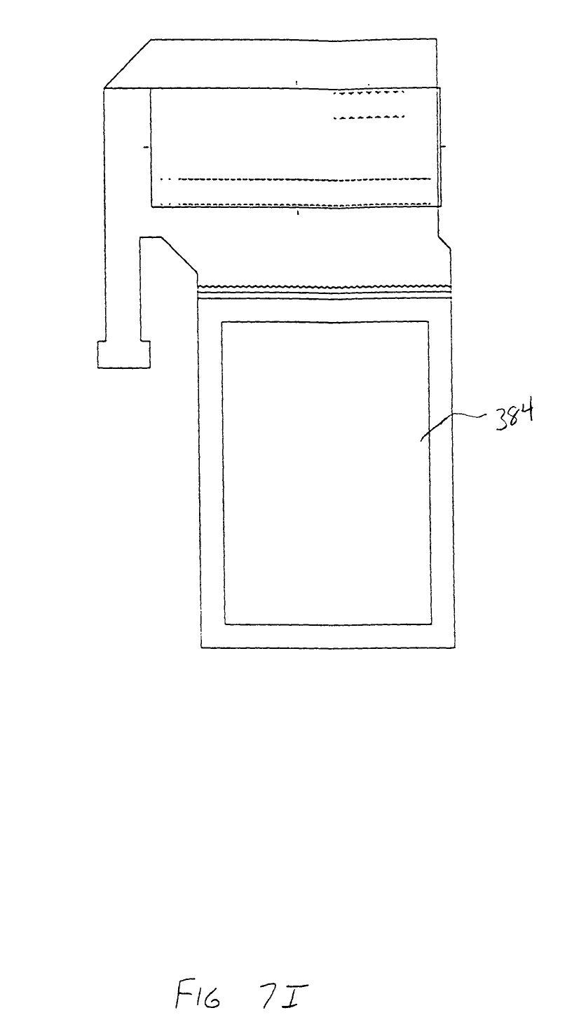

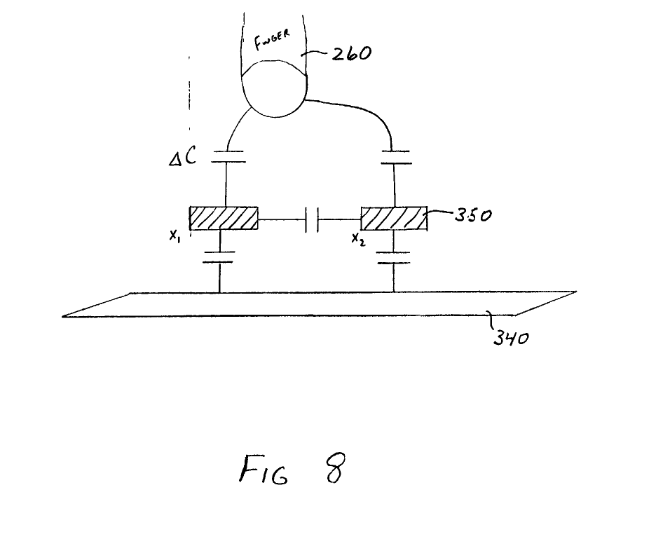

FIG. 8 depicts the operation of capacitive sensor 230. Although only shown for X-traces 360, the operation is similar for Y-traces 350. One at a time, each of X-traces 360 are coupled to a current source, while the others are coupled to GROUND. The system cycles through each of the traces many times every second. In the specific embodiment, the traces are sampled 40 times/second. In its steady state configuration, the capacitance on each of the traces has a value based on the stray capacitances between X-traces 360 and other elements in the system. Together, the capacitances total to a value of C₀ referencing the steady state capacitance of an individual trace. When pointing element 260 comes in close proximity to X-traces 360, the capacitance measured on each nearby X-trace is changed because of the presence of pointing element 260. This value, referred to herein as C_{finger}, is measured on each of X-traces 360. The change in capacitance is determined by subtracting C_{finger}—C₀.

In another embodiment of the present invention, the change in capacitance is determined by coupling two similar current sources to two adjacent traces and measuring the capacitance on each of the two adjacent traces. The change in capacitance may then be calculated by subtracting the capacitance of one from the capacitance on the other. An advantage of this method is that the system is less susceptible to variations due to noise on the traces. Both traces will be subject to substantially the same noise, and calculating the difference will cancel out the noise component. In yet another embodiment, the capacitance of adjacent traces may be added together, rather than subtracted.

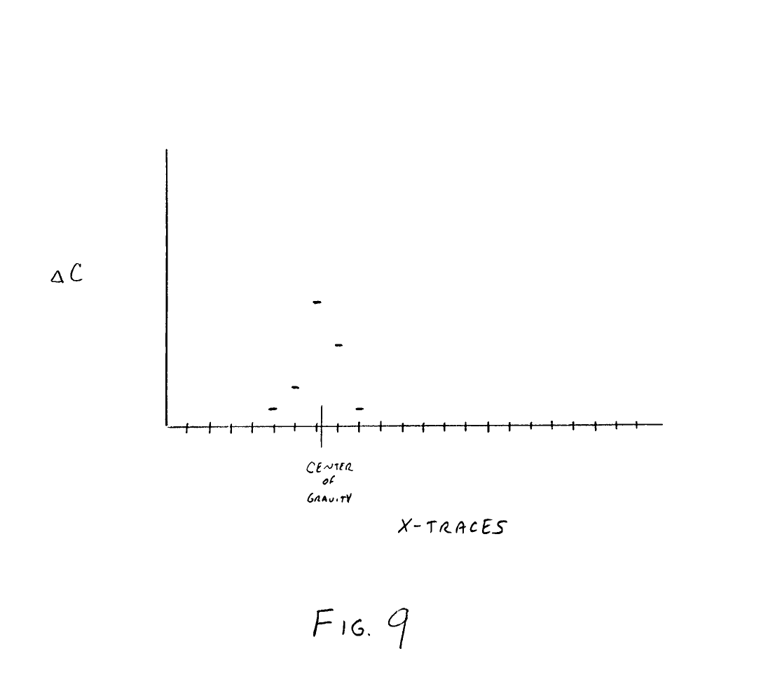

The position of the pointing element along the X-axis is extrapolated from the data determined by the above calculations for the set of X-traces 360. Because of the size of pointing element 260 and the effects of the capacitance of pointing element 260 on adjacent traces, more than one trace will register a changed capacitance value. This is shown graphically in FIG. 9, which is a graph of the change in capacitance for each of X-traces 360 for an exemplary situation. The location of pointing element 260 is determined by calculating the center of gravity for all the traces that register a change in capacitance. The location along the X-axis is the center of gravity. The operation is similarly performed and a center of gravity calculated for Y-traces 350 to determine the location along the Y-axis.

The present invention takes advantage of the characteristics of resistive sensor 210 and capacitive sensor 230 to anticipate the intentions of the user. For example, capacitive sensor will detect the presence of a finger, but will not detect the presence of a pen. Touchpad 200 takes advantage of this to distinguish between which type of pointing element 260 the user is using.

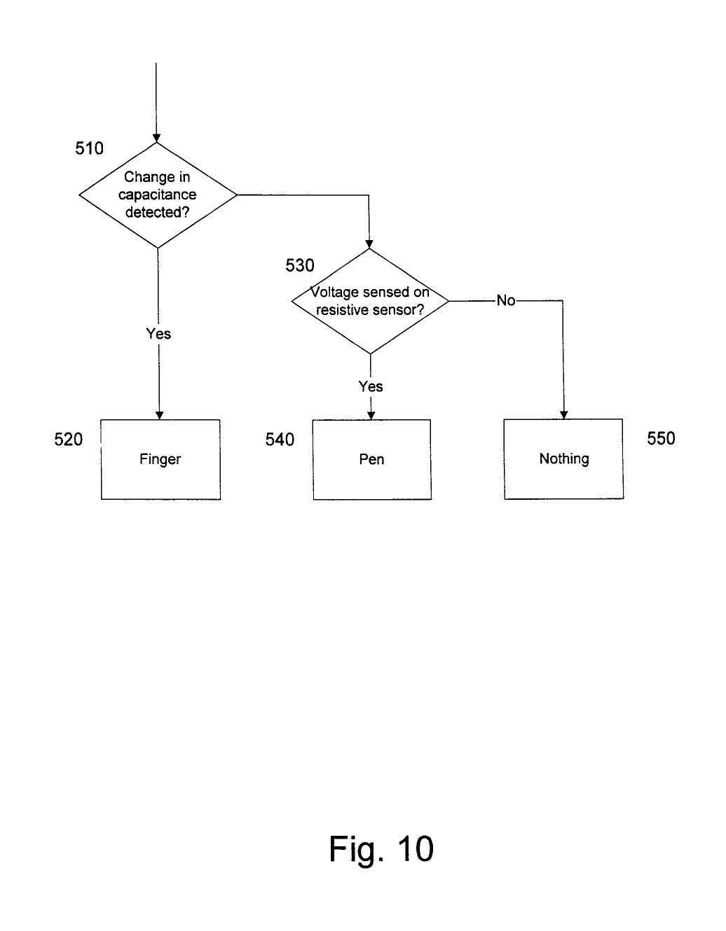

FIG. 10 is a flowchart of a method for detecting whether a pen or a finger is being used on touchpad 200. In step 510, capacitive sensor 230 is polled by the system to determine if a change in capacitance is detected. If it is, then in step 520 the system determines that pointing element 260 is a finger. However, if no change in capacitance is detected by the capacitive sensor 230, then in step 530, resistive sensor 210 is polled to determine if a voltage is present indicating the presence of pointing element 260. If a voltage is present, then in step 540 the system determines that pointing element is a pen. If both steps 510 and 530 produce negative results, then in step 550, the system determines that no pointing element 260 is present.

Of course, one of skill in the art can readily see that steps 510 through 550 may be done sequentially, or simultaneously. Further, the determination may be done in software, or in hardware built into touchpad 200 or a digital system 100 into which touchpad 200 is incorporated.

Once it is determined what type of pointing device 260 is being used, digital system 100 can alter its behavior to take advantage of user tendencies to perform certain functions with a finger, and other function with a pen. For example, a pen is more likely to be used for a handwriting applications and drawing operations, and the like, than it is for cursor positioning applications. However, a finger is more likely to be used for cursor positioning applications, and the like.

Thus, taking these tendencies into account, in an embodiment of the present invention, touchpad 200 is programmed to operate in a relative mode any time it detects a finger and in absolute mode whenever it detects a pen. Combining this embodiment with the method shown in FIG. 10, when touchpad 200 detects a change in capacitance, it goes into relative mode, and if it detects no change in capacitance, but it detects a voltage on resistive sensor 210, then it goes into absolute mode. In a preferred embodiment, the default modes of operation may be overridden by a user of the device. Of course, other embodiments may always operate in relative mode or absolute mode, or the modes may be determined by user or application control. In digital system 100, the determination of which mode of operation touchpad 200 operates in may be determined by firmware in the touchpad, driver software, operating system, or application software.

In another embodiment of the present invention, the determination of the type of pointing element 260 being used may affect the operation of applications being run on digital system 100. For example, touchpad 200 may operate to perform mouse-type operations as long as a finger is detected, but as soon as a pen is detected, then a specific application is launched; or, if it is already running, the specific application is moved to the active window. For instance, the finger may be used to manipulate the cursor, drag windows, and other functions, but when the use of a pen is detected, a specific application such as a handwriting or drawing application may be automatically executed.

Alternatively, instead of directly launching the application, a pop-up menu may be displayed upon detection of the pen, allowing the user to choose an application from a list of applications. Yet another embodiment launches different applications based on a particular movement by the user with the pen. So, for example, if the pen is double-tapped on touchpad 200, then a particular application is launched, while the user may trace a certain pattern on touchpad 200 to perform a different function. One of skill in the art can readily imagine many different actions that could be distinguished such as tapping, pen down and hold versus pen down and move, and other distinguishing actions.

In yet another embodiment of the present invention, a single application may respond differently depending on the type of pointing element 260 being used. So, rather than having some applications operate with a finger, and other applications operate with a pen, different actions are taken within a single application depending on the type of pointing element 260 being used.

The above description has focused on detecting a pen with the resistive sensor and a finger with the capacitive sensor. However, other ways of switching modes of operation may be performed by the present invention. Various operations can be distinguished by resistive sensor 210 depending on the pressure applied by the user. If the user uses a light touch, only a relatively small surface area of sensor plane 245 comes into contact with resistive plane 310. However, if the user presses harder, then a larger surface area of sensor plane 245 comes into contact with resistive plane 310. By sensing the size of the surface area, resistive sensor 310 can distinguish between different pressures, and therefore different intentions of the user. Similarly, capacitive sensor 230 may also distinguish different pressures by the user. Pressing hard on touchpad 200 will cause more of X-traces 360 and Y-traces 350 to register capacitance changes.

Another way in which modes of operation may be distinguished is by the rate of movement of pointing element 260 across touchpad 200. A particular application or group of applications may perform differently depending on how fast pointing element 260 is moved. For example, screen scrolling rates of screens may based on the rate of movement of pointing element 260.

In applications, this may be translated in various ways that are intuitive to the user. For example, in a scrolling operation, a light touch may cause slow scrolling while a heavier touch may increase the scrolling rate. Or, scrolling may occur with a light touch, while a heavier touch caused the image to zoom in or out. Also, in a drawing application, a light touch may be used to select various items, and a heavier touch used to drag them. One of skill in the art will readily see many applications that may be benefitted by distinguishing between different pressures by resistive sensor 210 or capacitive sensor 230.

While the above is a complete description of specific embodiments of the invention, various modifications, alternative constructions, and equivalents may be used. For example, both resistive sensor 210 and capacitive sensor 230 may be used at the same time to detect multiple pointing elements. Therefore, the above description should not be taken as limiting the scope of the invention as defined by the claims.

What is claimed is:

1. An input device comprising:
a resistive sensor for detecting a first type of pointing element; and
a capacitive sensor for detecting a second type of pointing element, wherein the input device operates in a first mode when the first type of pointing element is detected, and the input device operates in a second mode if the second type of pointing element is detected.

2. The input device of claim 1 wherein the resistive sensor is deactivated when the capacitive sensor detects the second type of pointing element.

3. The input device of claim 1 wherein the first mode is one of the set including relative mode and absolute mode.

4. The input device of claim 1 wherein the second mode is absolute mode.

5. The input device of claim 1 wherein the resistive sensor and the capacitive sensor operate independently of one another.

6. A digital system comprising an input device as recited in claim 1.

7. An input device comprising:
a first substrate, the first substrate having printed thereon:
a resistive plane;
a low resistive frame;
a routing layer; and
a spacer frame;
a second substrate, the second substrate having printed thereon:
a sensor plane;
a first plurality of traces substantially disposed in a first direction;
a second plurality of traces substantially disposed in a second direction; and
a first dielectric separating the first plurality of traces from the second plurality of traces;
a second dielectric separating the first plurality of traces from the sensor plane;
wherein the first substrate is coupled to the second substrate such that the sensor plane is separated from the resistive plane by the spacer frame, whereby displacement of the sensor plane causes the sensor plane to contact the resistive plane.

8. The input device of claim 7 further comprising a label attached to the second substrate.

9. The input device of claim 7 further comprising circuitry for determining the voltage on the sensor plane when it is in contact with the resistive plane.

10. The input device of claim 7 further comprising circuitry for detecting a change in capacitance on the first and second plurality of traces when a pointing element is in proximity to the input device.

11. The input device of claim 7 further comprising a routing layer printed on the second substrate.

12. A method of detecting the position of a pointing element on an input device comprising the steps of:
providing a resistive sensor and a capacitive sensor;
if the capacitive sensor detects a pointing element, then
ignoring the resistive sensor; and
determining the position of the pointing element with the capacitive sensor; and
if the capacitive sensor does not detect a pointing element then determining the position of the pointing element with the resistive sensor.

13. The method of claim 12 further comprising the step of deactivating the resistive sensor when the capacitive sensor detect the pointing element.

14. A method of operation for a touchpad comprising the steps of:
detecting a pointing element; and
determining if the pointing element is a first type of pointing element or second type of pointing element.

15. The method of claim 14 further comprising the steps of:
operating in a first mode if the pointing element is the first type of pointing element; and
operating in a second mode if the pointing element is the second type of pointing element.

16. The method of claim 15 wherein the first mode is relative mode and the second mode is absolute mode.

17. The method of claim 16 wherein the first mode and the second mode are the same mode.

18. The method of claim 14 wherein the first type of pointing element is a finger and the second type of pointing element is in the set consisting of a pen and a stylus.

19. The method of claim 15 wherein the first mode of operation is a cursor control operation.

20. The method of claim 15 wherein the second mode of operation is the execution of an application.

21. The method of claim 15 wherein the second mode of operation is the display of a pop-up menu, the pop-up menu displaying a list of applications.

22. The method of claim 20 further comprising the steps of:
detecting whether the second type of pointing element is moved in a first movement or a second movements; and
executing a first application if the first movement is detected and a second application if the second movement is detected.

23. The method of claim 14 wherein the determining step distinguishes between the first and second types of pointing elements by the amount of pressure applied to the touchpad by the pointing element.

24. The method of claim 14 wherein the determining step determines that the pointing element is the first type if a capacitive sensor detects a change in capacitance.

25. The method of claim 24 wherein the determining step determines that the pointing element is a the second type if a first conductor of a resistive sensor is brought into contact with a second conductor of the resistive sensor.

26. A digital system comprising:
an input device including a resistive sensor for detecting a first type of pointing element and a capacitive sensor for detecting a second type of pointing element;
code executing on the digital system, wherein the code operates in a first mode when the first type of pointing element is detected and in a second mode when the second type of pointing element is detected.

27. The digital system of claim 26 further comprising first and second application programs in the code, wherein the input device controls the first application program when the first type of pointing element is detected, and the input device controls the second application program when the second type of pointing element is detected.

28. An input device comprising:
a capacitive sensor; and
a 5-wire resistive sensor.

29. The input device of claim 28 wherein a first conductive plate of the 5-wire resistive sensor is printed on a first substrate, and a second conductive plate of the 5-wire resistive sensor is printed on a second substrate, the capacitive sensor also being printed on the second substrate.
